(19) United States
(12) Patent Application Publication
(10) Pub. No.: US 2013/0021485 A1
(43) Pub. Date: Jan. 24, 2013

(54) Image-Capturing Device

(71) Applicant: Ting-Rung Hsu, Changhua County (TW)

(72) Inventor: Ting-Rung Hsu, Changhua County (TW)

(73) Assignee: Asia Optical Co., Inc.

(21) Appl. No.: 13/368,492

(22) Filed: Feb. 8, 2012

(30) Foreign Application Priority Data
Jul. 22, 2011 (TW) 100126018

(51) Int. Cl. H04N 5/247

(52) U.S. Cl. 348/208.99; 348/E05.048

(57) ABSTRACT

An image-capturing device includes a periscope-type zooming lens unit, an optical image stabilizing (OIS) unit, and a protecting cap. The periscope-type zooming lens unit includes a housing and a lens set that is disposed in the housing and that includes a reflective prism and an emission lens. The OIS unit is disposed externally of the periscope-type zooming lens unit and adjacent to the emission lens. The OIS unit includes a base mounted to the housing of the periscope-type zooming lens unit, a movable carrier mounted to the base, an optical sensor mounted on the movable carrier to correspond with the emission lens, and a driving mechanism operable to drive the movable carrier to move relative to the base. The protecting cap is mounted to the base of the OIS unit, and is disposed to surround an outer side of the OIS unit.

### CROSS-REFERENCE TO RELATED APPLICATION

This application claims priority of Taiwanese Application No. 100126018, filed on Jul. 22, 2011.

### BACKGROUND OF THE INVENTION

1. Field of the Invention

The present invention relates to an image-capturing device, more particularly to an image-capturing device with a periscope-type zooming lens unit.

2. Description of the Related Art

Taiwanese Patent Application Pub. No. 201030370 discloses a conventional image-capturing device that includes a periscope-type zooming lens unit suitable to be mounted within a cell phone, an ultra-thin digital camera, etc. There is an optical image stabilizing (OIS) device mounted in a housing of the periscope-type zooming lens unit. Since the size of the housing is relatively small, the size of the OIS device is limited so that a driving force provided by the OIS device is relatively small. As a result, the OIS device can only be loaded with a relatively light lens unit.

The OIS device may have a relatively larger size if it is disposed externally of the housing of the periscope-type zooming lens unit. However, the OIS device may be damaged easily when the cell phone or the ultra-thin digital camera provided therewith is subjected to impact.

Taiwanese Patent Application Pub. No. 201014342 discloses another conventional image-capturing device that includes an optical image stabilizing (OIS) module. Generally, the OIS module is mounted between a retractable-type zooming lens unit and a liquid-crystal-display (LCD) support, and is protected by the LCD support.

However, in the case of the OIS device disposed externally of the housing of the periscope-type zooming lens unit, only one side of the OIS device that is adjacent to the LCD support is protected.

### SUMMARY OF THE INVENTION

Therefore, an object of the present invention is to provide an image-capturing device capable of protecting an optical image stabilizing unit thereof.

Accordingly, an image-capturing device of this invention comprises a periscope-type zooming lens unit, an optical image stabilizing (OIS) unit, and a protecting cap. The periscope-type zooming lens unit includes a housing and a lens set that is disposed in said housing and that includes a reflective prism and an emission lens. The OIS unit is disposed externally of the periscope-type zooming lens unit and adjacent to the emission lens. The OIS unit includes a base mounted to the housing of the periscope-type zooming lens unit, a movable carrier mounted to the base, an optical sensor mounted on the movable carrier to correspond with the emission lens, and a driving mechanism operable to drive the movable carrier to move relative to the base. The protecting cap is mounted to the base of the OIS unit, and is disposed to surround an outer side of the OIS unit.

According to another aspect, an image-capturing device of this invention is for mounting with a periscope-type zooming lens unit. The image-capturing device comprises an OIS unit and a protecting cap. The OIS unit includes a base to be mounted to the periscope-type zooming lens unit, a movable carrier mounted to the base, an optical sensor mounted on the movable carrier, and a driving mechanism operable to drive the movable carrier to move relative to the base. The protecting cap is mounted to the base of the OIS unit, and is disposed to surround an outer side of the OIS unit.

According to vet another aspect, an image-capturing device of this invention comprises an OIS unit and a protecting cap. The OIS unit includes abase, a movable carrier mounted to the base, an optical sensor mounted on the movable carrier, and a driving mechanism operable to drive the movable carrier to move relative to the base. The protecting cap is mounted to the base of the OIS unit, and is disposed to surround an outer side of the OIS unit.

### BRIEF DESCRIPTION OF THE DRAWINGS

Other features and advantages of the present invent ion will become apparent in the following detailed description of the preferred embodiment with reference to the accompanying drawings, of which:

FIG. 1 is a cross-sectional view of a preferred embodiment of an image-capturing device of this invention when mounted within a camera;

FIG. 2 is a perspective exploded view illustrating a periscope-type zooming lens unit, an optical image stabilizing (OIS) unit and a protecting cap of the image-capturing device of the preferred embodiment;

FIG. 3 is a perspective exploded view illustrating components of the OIS unit of the image-capturing device of the preferred embodiment; and

FIG. 4 is a perspective view illustrating the protecting cap surrounding an outer side of the OIS unit.

### DETAILED DESCRIPTION OF THE PREFERRED EMBODIMENT

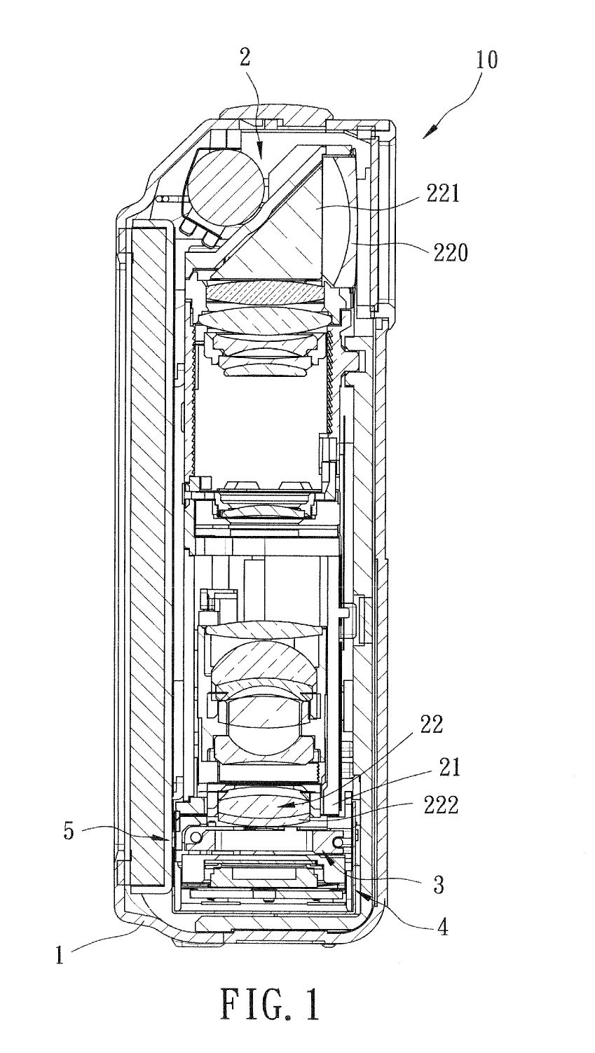

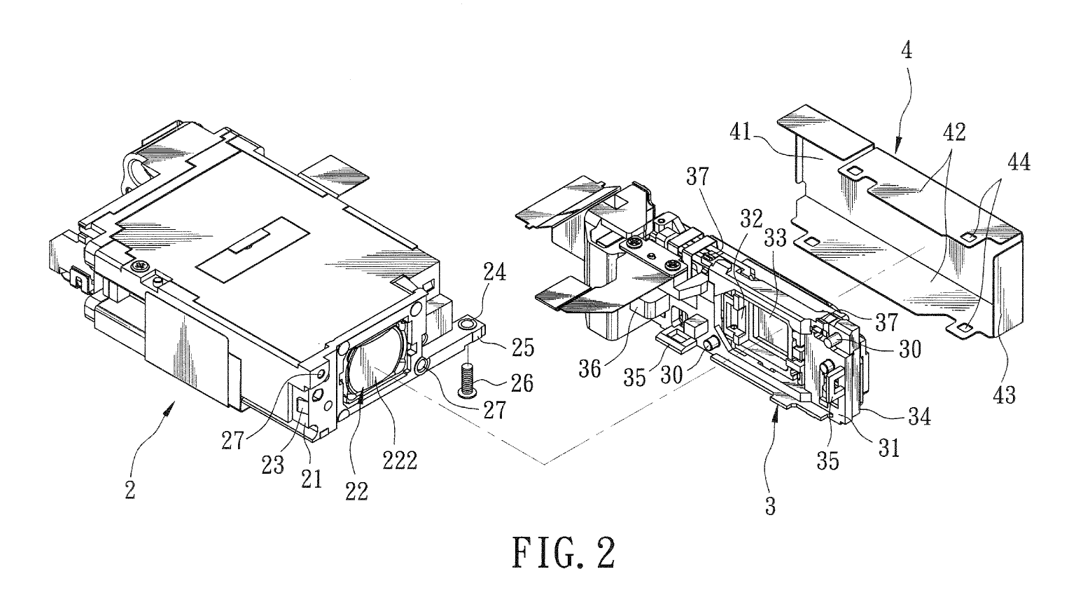

Referring to FIGS. 1 and 2, a preferred embodiment of an image-capturing device according to this invention is installed in a housing 1 of a camera 10. The image-capturing device of this embodiment includes a periscope-type zooming lens unit 2, an optical-image-stabilizing (OIS) unit 3, and a protecting cap 4. Generally, the camera 10 includes a supporter 5 for supporting a liquid crystal display.

The periscope-type zooming lens unit 2 includes a housing 21, a lens set 22 disposed in the housing 21, a plurality of first male engaging components 23 (only one is shown) disposed on and projecting outwardly from the housing 21, and a positioning plate 25 formed with a threaded hole 24. The housing 21 is formed with a pair of pin holes 27. The lens set 22 includes an incident lens 220, a reflective prism 221, and an emission lens 222 through which the light is transmitted in sequence. Generally, the lens set 22 further includes a group of movable zooming lenses disposed between the reflective prism 221 and the emission lens 222 with respect to the ratio of longest and shortest focal lengths of the lens set 22 (i.e., the zooming ratio). The reflective prism 221 is used to reflect the light from the incident lens 220 at an angle of 90°, and then, the reflected light is transmitted through the group of the zooming lenses to the emission lens 222.

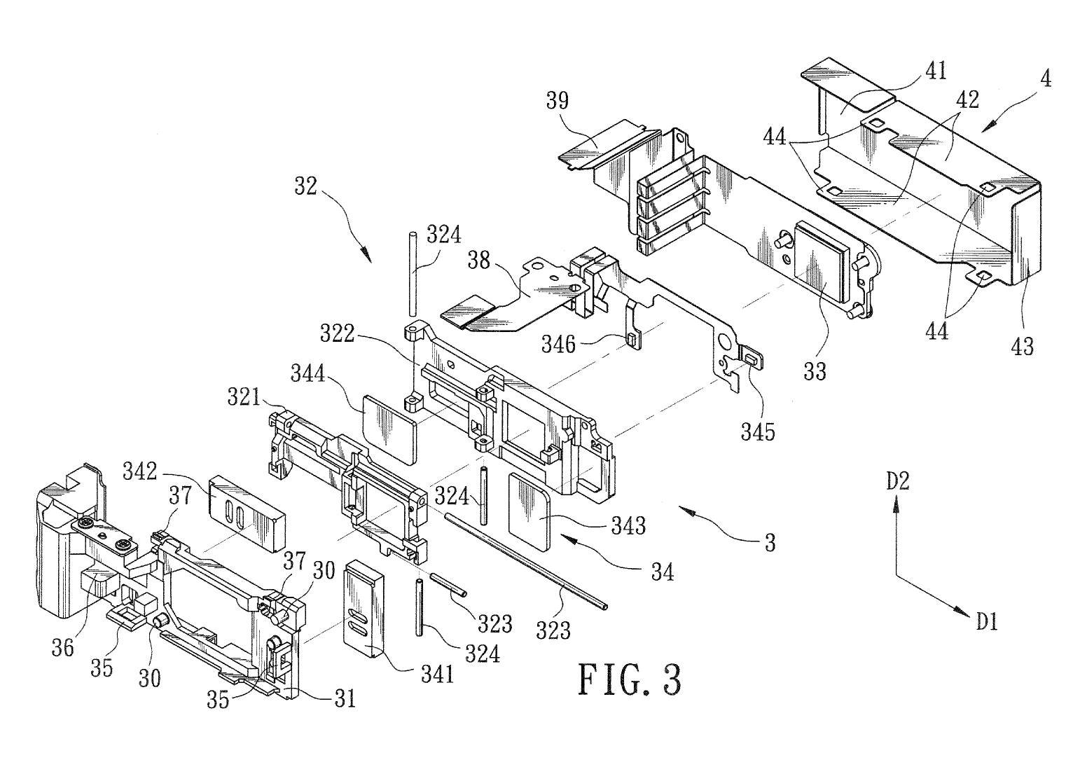

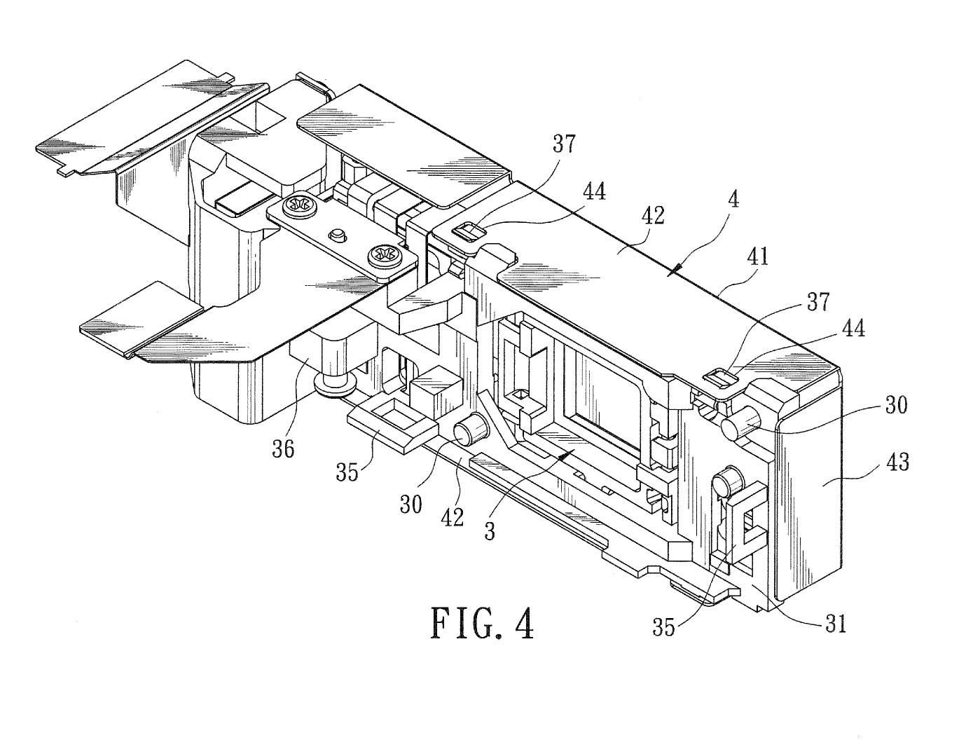

Referring to FIGS. 2 to 4, the OIS unit 3 is disposed externally of the periscope-type zooming lens unit 2 and adjacent to the emission lens 222. The OIS unit 3 includes a base 31 mounted to the housing 21 of the periscope-type zooming lens unit 2, a movable carrier 32 mounted to the base 31, an optical sensor 33 mounted on the movable carrier 32 to correspond with the emission lens 222, a driving mechanism 34 operable to drive the movable carrier 32 to move relative to the base 31, a positioning block 36 disposed to correspond to the positioning plate 25 of the periscope-type zooming lens unit 2, and a pair of pins 30 disposed to correspond to the pin holes 27. The base 31 includes a plurality of first female engaging components 35 corresponding respectively to the first male engaging components 23 of the periscope-type zooming lens unit 2, and a plurality of second male engaging components 37 projecting from the base 31. In this embodiment, each of the first female engaging components 35 is in a form of a buckle, and each of the first male engaging components 23 is in a form of a barb matching with the buckle of a corresponding one of the first female engaging components 35.

When the OIS unit 3 is mounted to the periscope-type zooming lens unit 2, the first male engaging components 23 of the periscope-type zooming lens unit 2 engage the first female engaging components 35 of the base 31 of the OIS unit 3, respectively. Further, the positioning plate 25 of the periscope-type zooming lens unit 2 is fixedly connected to the positioning block 36 of the OIS unit 3 using a screw 26 extending through the threaded hole 24 in the positioning plate 25 and threaded into the positioning block 36. The pins 30 are inserted into the pin holes 27, respectively. It should be noted that, in other embodiments, the first male engaging components 23 may be disposed on the base 31 of the OIS unit 3, and correspondingly, the first female engaging components 35 may be disposed on the housing 21 of the periscope-type zooming lens unit 2.

In particular, the movable carrier 32 of the OIS unit 3 includes a first moving frame 321 movable with respect to the base 31 along a first direction (D1), and a second moving frame 322 movable with respect to the first moving frame 321 along a second direction (D2) transverse to the first direction (D1). The movable carrier 32 further includes a plurality of first pivot axles 323 extending through the first moving frame 321 and mounted to the base 31, and a plurality of second pivot axles 324 extending through the second moving frame 322 and mounted to the first moving frame 321. In this embodiment, there are two first pivot axles 323 and three second pivot axles 324. The driving mechanism 34 includes a pair of magnets 341, 342 mounted on the base 31, a pair of coils 343, 344 mounted on the second moving frame 322, and a pair of Hall elements 345, 346 mounted on the second moving frame 322. The coils 343, 344 and the Hall elements 345, 346 are electrically connected to a first flexible circuit board 38 that is mounted to the second moving frame 322, and the optical sensor 33 is electrically connected to a second flexible circuit board 39 that is mounted to the second moving frame 322.

During compensating for hand shaking, the coils 343 and 344 will generate magnetic fields with predetermined intensity so as to move with respect to the magnets 341 and 342, respectively. As a result, the second moving frame 322 and the optical sensor 33 move with respect to the base 31 in the first and second directions (D1), (D2). The Hall elements 345 and 346 are used for detecting positions of the magnets 341 and 342, respectively. Thus, the optical sensor 33 maybe placed at a predetermined position with respect to the emission lens 222 so that the optical image stabilizing effect may be achieved.

It should be noted that, in other embodiments, the first and second moving frames 321, 322 may be replaced by a single movable component, such as a conventional movable component disclosed in Taiwanese Patent Application Publication No. 201030370 with a reference numeral of 110. Aside from the disclosed magnets 341, 342 and coils 343, 344 providing the magnetic force to move the movable carrier 32, the driving mechanism 34 may have other configurations, such as a motor configuration, for driving the movable carrier 32. Since such modifications are well known to those skilled in the art, details thereof will be omitted herein for the sake of brevity.

The protecting cap 4 is mounted to the base 31 of the OIS unit 3, and is disposed to surround an outer side of the OIS unit 3. The protecting cap 4 includes a rectangular base plate 41 having an opposite pair of short sides and an opposite pair of long sides, a pair of long-side plates 42 connected respectively to the long sides of the base plate 41, a short-side plate 43 connected to one of the short sides of the base plate 41, and a plurality of second female engaging components 44 corresponding to the second male engaging components 37 of the base 31. In this embodiment, there are four second female engaging components 44 each of which is in a form of a buckle, and two of them are disposed at one of the long-side plates 42 and the other two are disposed at the other one of the long-side plates 42. The number of the second male engaging components 37 is equal to four, and each of the second male engaging components 37 is in a form of a barb matching with the buckle of a corresponding one of the second female engaging components 44. When the protecting cap 4 is mounted to the OIS unit 3, the second male engaging components 37 of the OIS unit 3 engage the second female engaging components 44 of the protecting cap 4, respectively. It should be noted that, in other embodiments, the second male engaging components 37 may be disposed at the protecting cap 4, and correspondingly, the second female engaging components 44 may be disposed at the OIS unit 3.

In summary, since the OIS unit 3 is disposed externally of the periscope-type zooming lens unit 2, the size of the OIS unit 3 will not be limited by the size of the housing 21 of the periscope-type zooming lens unit 2. When the camera 10 is subjected to impact, the OIS unit 3 is protected by the protecting cap 4 that surrounds the OIS unit 3. Moreover, the periscope-type zooming lens unit 2 and the OIS unit 3 can be manufactured separately. During manufacture, the OIS unit 3 is protected and dust-free by virtue of the protecting cap 4 so that quality of the image-capturing device according to this invention can be ensured.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An image-capturing device comprising:
a periscope-type zooming lens unit including a housing and a lens set disposed in said housing, said lens set including a reflective prism and an emission lens;
an optical image stabilizing (OIS) unit disposed externally of said periscope-type zooming lens unit and adjacent to said emission lens, said OIS unit including a base mounted to said housing of said periscope-type zooming lens unit, a movable carrier mounted to said base, an optical sensor mounted on said movable carrier to correspond with said emission lens, and a driving mechanism operable to drive said movable carrier to move relative to said base; and
a protecting cap mounted to said base of said OIS unit and disposed to surround an outer side of said OIS unit.

2. The image-capturing device as claimed in claim 1, wherein one of said housing of said periscope-type zooming lens unit and said base of said OIS unit includes at least one first male engaging component, and the other one of said housing and said base includes at least one first female engaging component corresponding to said at least one first male engaging component.

3. The image-capturing device as claimed in claim 2, wherein said periscope-type zooming lens unit further includes a positioning plate formed with a threaded hole, a bolt extending through said threaded hole of said positioning plate, and at least one pin hole formed in said housing, and said OIS unit further includes a positioning block disposed to correspond to said positioning plate, and at least one pin disposed to correspond to said at least one pin hole.

4. The image-capturing device as claimed in claim 1, wherein one of said base of said OIS unit and said protecting cap includes at least one second male engaging component, and the other one of said base and said protecting cap includes at least one second female engaging component corresponding to said at least one second male engaging component.

5. The image-capturing device as claimed in claim 1, wherein said movable carrier of said OIS unit includes a first moving frame movable with respect to said base along a first direction, and a second moving frame movable with respect to said first moving frame along a second direction transverse to the first direction.

6. The image-capturing device as claimed in claim 5, wherein said driving mechanism includes a pair of magnets mounted on said base, a pair of coils mounted on said second moving frame, and a pair of Hall elements mounted on said second moving frame.

7. An image-capturing device for mounting with a periscope-type zooming lens unit, said image-capturing device comprising:
an optical image stabilizing (OIS) unit including a base to be mounted to the periscope-type zooming lens unit, a movable carrier mounted to said base, an optical sensor mounted on said movable carrier, and a driving mechanism operable to drive said movable carrier to move relative to said base; and
a protecting cap mounted to said base of said OIS unit and disposed to surround an outer side of said OIS unit.

8. The image-capturing device as claimed in claim 7, wherein one of said base of said OIS unit and said protecting cap includes at least one male engaging component, and the other one of said base and said protecting cap includes at least one female engaging component corresponding to said at least one male engaging component.

9. The image-capturing device as claimed in claim 7, wherein said movable carrier of said OIS unit includes a first moving frame movable with respect to said base along a first direction, and a second moving frame movable with respect to said first moving frame along a second direction transverse to the first direction.

10. The image-capturing device as claimed in claim 9, wherein said driving mechanism includes a pair of magnets mounted on said base, a pair of coils mounted on said second moving frame, and a pair of Hall elements mounted on said second moving frame.

11. An image-capturing device comprising:
an optical image stabilizing (OIS) unit including a base, a movable carrier mounted to said base, an optical sensor mounted on said movable carrier, and a driving mechanism operable to drive said movable carrier to move relative to said base; and
a protecting cap mounted to said base of said OIS unit and disposed to surround an outer side of said OIS unit.
